(19) United States
(12) Patent Application Publication
(10) Pub. No.: US 2021/0039162 A1
(43) Pub. Date: Feb. 11, 2021

(54) DEVICE AND METHOD FOR HANDLING OF CAST PRODUCT

(71) Applicant: NORSK HYDRO ASA, Oslo (NO)

(72) Inventors: Geir Olav ÅNESBUG, Frei (NO); John Olav FAGERLIE, Sunndalsøra (NO)

(73) Assignee: NORSK HYDRO ASA, Oslo (NO)

(21) Appl. No.: 17/044,498

(22) PCT Filed: May 14, 2019
(86) PCT No.: PCT/EP2019/062325

§ 371 Date: Oct. 1, 2020

(30) Foreign Application Priority Data
Jun. 15, 2018 (NO) 20180843

(51) Int. Cl. B22D 29/04; B66C 23/18

(52) U.S. Cl. CPC B22D 29/04; B66C 23/18

(57) ABSTRACT

Lifting device for lifting a longitudinal cast product from a casting pit, the cast product arranged in the casting pit such that a longitudinal axis of the cast product is in a vertical direction, the device having a support structure that is, optionally permanently, fixed to a ground surrounding the casting pit, a lifting structure that has an end that is rotatably connected to the support structure via a support bearing, a head that is, optionally rotatably, connected to the lifting structure and that can selectively attach to the cast product.

### TECHNICAL FIELD

The present invention relates to devices and methods for handling a cast product, in particular for lifting a cast product in a casting equipment after a direct chill casting process, e.g. to lift the cast product out of the casting pit for further processing.

### BACKGROUND OF THE INVENTION

In the production of metal, cast objects in various formats are produced, for example sheet ingots that are used to produce flat metal products by hot rolling and cold rolling and billets that are used to produce extruded products with different cross-sections and designs by an extrusion process.

Both sheet ingots and billets may be produced by semi-continuous casting equipment that may comprise a large number of chills arranged in lines and rows in a frame structure. Liquid metal is led to the chills via a metal manifold through a hot-top from above into a cavity of each chill. The metal is cooled and solidified in two stages. The first stage is called primary cooling, in which the initial solidification of the metal is achieved via cooling through the wall of the cavity in the chill. The second stage is called secondary cooling, in which water immediately below the primary cooling area is sprayed directly against the metal via a water gap or holes along the circumference of the chill. The casting equipment may be placed over a casting pit with a depth corresponding to the length of the products to be cast plus the structural height of a mobile support. A total depth of such a casting pit may be in the order of 10-11 meters. The mobile support or starter block under the chills is moved downwards as the metal solidifies in order to create the longitudinal cast product which may have for example a diameter between 150 and 400 mm, depending on the intended use of the cast product, i.e. whether it is intended for a subsequent rolling process or extrusion process. A casting equipment of the mentioned type is also referred to as a “direct chill (DC) casting equipment” and is e.g. described in European Patent EP1648635B1, the whole content of which is incorporated herein by this reference. However, the methods and devices according to the present invention may be used with any casting equipment.

For subsequent production steps, the cast product needs to be removed from the casting pit. To achieve this, the casting equipment may be lifted, pivoted or removed in some other way from the opening of the casting pit so that the cast products are exposed and can be removed from the casting pit.

This removal is conventionally performed using an overhead crane (bridge crane) with a spreader that is provided with a number of rings, each of which is connected to the spreader with a wire. Each of the rings is threaded manually down onto the end of a billet and, by lifting the spreader and thus pulling on each wire, each ring is pulled obliquely so that, by squeezing, it retains the billet onto which it is threaded and can lift the billet. In each lifting operation, a row of billets is normally lifted right out of the pit at once and then laid horizontally on a transport device, normally a roller conveyor, for transport to a store or further treatment/processing. The lifting operation in which the billets are lifted right out of the casting pit means that the fall height for the billets is high in the event of an accident. This, along with the fact that the billets are handled manually, entails a high risk for the operators who perform the work and a risk of serious injury to them.

Alternatively, the exposed cast product may be removed from the casting pit using a dolly as described e.g. in U.S. Pat. No. 8,800,636B2. However, the technology described in this document requires a large floor space in a cast house due to the need for a ramp leading into the casting pit. Said large floor space is not available in all cast houses so that retrofitting the technology is not possible and also may increase building cost in case of a newly built “green field” cast house.

It is therefore desirable to have more efficient devices and methods to remove a cast product from a casting pit.

### SHORT DESCRIPTION OF THE INVENTION

The present invention is directed to solving or mitigating the problems mentioned above and provides more efficient devices and methods to remove a cast product from a casting pit.

According to an embodiment, the invention may provide a device for lifting (herein also referred to as “lifting device” or “device”) a longitudinal cast product upwards, e.g. to remove it from a casting pit, wherein the cast product is arranged in the casting pit such that a longitudinal axis of the cast product is arranged in a vertical direction, the device comprising a support structure that is, optionally permanently, fixed to a ground, in particular a floor of a casting facility such as a cast house, surrounding the casting pit, a lifting structure that has an end (e.g. a proximal end) that is rotatably or pivotably connected to the support structure via a support bearing, a head that is, optionally rotatably, connected to the lifting structure (e.g. at a distal end of the lifting structure) and that can selectively attach to the cast product, wherein a lifting distance is defined between the support bearing and the head, wherein the device is configured such that in order to lift the cast product from the casting pit, the lifting structure is rotated in a first direction around the support bearing to come into contact with the cast product in the casting pit, the head is selectively attached to the cast product, and the arm is rotated in a second, opposite direction around the support bearing while the head is attached to the cast product to lift the cast product out of the casting pit.

According to a further embodiment, the lifting structure may comprise a first and a second longitudinal lifting arm, wherein the first lifting arm and the second lifting arm may each be rotatably connected to the support structure via a respective support bearing, and wherein the head may be arranged transversely with respect to the first and second lifting arm and may be connected to the first and the second lifting arm.

According to a further embodiment, the lifting structure may comprise means to adjust the lifting distance.

According to a further embodiment, the means to adjust the lifting distance may be implemented by at least one axially adjustable bearing, in particular an axially adjustable telescopic bearing.

According to a further embodiment, the means to adjust the lifting distance may be implemented by at least one joint that divides/articulates the lifting structure into segments that are movable, e.g. rotatable, relative to each other, wherein the first and the second lifting arm may each comprise at least one joint that divides/articulates the respective lifting arm into segments that are movable relative to each other.

According to a further embodiment, the lifting structure may comprise at least one actuator, optionally a hydraulic actuator.

According to a further embodiment, the head may be configured such that it can selectively attach to more than one cast product simultaneously.

According to a further embodiment, a plurality of cast products may be arranged in the casting pit in rows transverse to a direction of the lifting distance and in columns parallel to the direction of the lifting distance such as to form a matrix arrangement, wherein the head may configured to attach to all cast products of one of the rows simultaneously, and wherein a row from the matrix arrangement may be selected by adjusting the lifting distance such that all cast products can be lifted from the casting pits in a number of lifting operations that corresponds to the number of rows in the matrix arrangement.

According to a further embodiment, the device may comprise means for rotating the cast products from a vertical direction into a horizontal direction, for example to place the cast products on a conventional lay down station in a cast house.

According to a further embodiment, the lifting structure may be configured such that a vertical movement of the head and a horizontal movement of the head can be controlled independently from each other. The control may be simultaneous for the vertical and the horizontal movement.

According to an embodiment, the invention provides a method for lifting longitudinal cast products from a casting pit, wherein the cast products are arranged in rows and columns forming a matrix arrangement in the casting pit, and wherein a longitudinal direction of the cast products in the casting pit is vertical, the method comprising determining a row of cast products that is to be lifted out of the casting pit, determining a distance between a stationary part, in particular a support structure, of a lifting device and the row of cast products to be lifted out of the casting pit, adjusting a lifting distance of the lifting device based on the determining the distance, rotating a lifting structure of the lifting device in a first direction about the stationary part such that a head of the lifting device is moved towards the row of cast products, attaching the head to the cast products of the determined row of cast products, rotating the lifting structure in a second, opposite direction with the cast products attached to the head such as to lift the cast products out of the casting pit, and rotating the cast products from the vertical direction into a horizontal direction. According to embodiments, a row of cast products as described herein may comprise only one cast product or may comprise more than one cast product.

Further embodiments of the invention are shown in the figures and described in the specification.

### SHORT DESCRIPTION OF THE FIGURES

FIG. 1 shows a schematic view of a device for lifting according to an embodiment of the invention.

FIG. 2 shows a schematic perspective view of a device for lifting according to an embodiment of the invention.

FIGS. 3a and 3b schematically show means to adjust a lifting distance according to embodiments of the invention.

FIG. 4 shows a detailed view of an embodiment of a lifting structure according to the invention.

FIGS. 5 to 7 show an embodiment of a device for lifting according to an embodiment of the invention in operation, wherein in FIG. 6, the longitudinal axis of the cast products attached to the head are vertically arranged and in FIG. 7 are horizontally arranged.

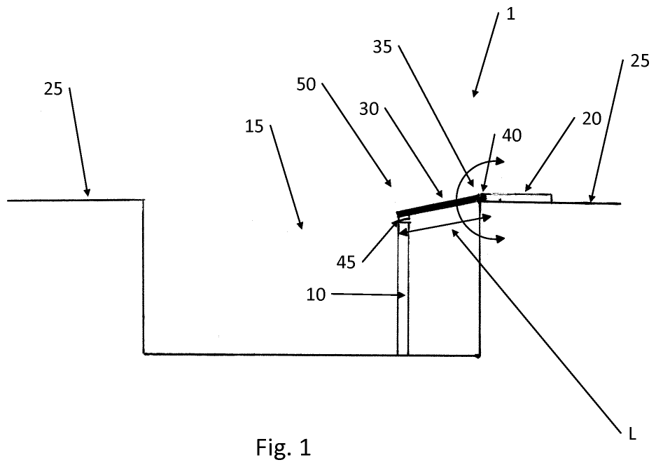

FIGS. 1 to 3 are not to scale and are schematic views showing some principles employed by embodiments according to the present invention in an abstract manner.

### DETAILED DESCRIPTION OF THE INVENTION

FIG. 1 shows a schematic, not to scale view of a device for lifting according to an embodiment of the invention. With reference to FIG. 1, the invention provides a device 1 for lifting a longitudinal cast product 10 from a casting pit 15. After the casting process, in particular a DC casting process, is finished, the cast product 10 is arranged in the casting pit 15 such that a longitudinal axis of the cast product 10 corresponds to the vertical direction. The cast product 10 may have generally longitudinal shape with a circular, rectangular or other cross-section. The device 1 may comprise a support structure 20. The support structure 20 may be fixed to a ground, e.g. to the floor 25 of a casting facility. The support structure 20 may be permanently fixed to the floor 25 surrounding the casting pit 15, for example via bolts and nuts, by being partially cast in concrete, etc.

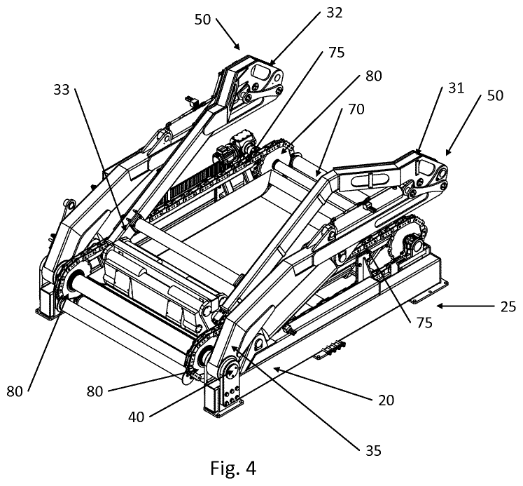

The device 1 may further comprise a lifting structure 30. The lifting structure 30 may have an end (proximal end) 35 that may be rotatably connected to the support structure 20. The proximal end 35 may be connected to the support structure 20 via a support bearing 40. The support bearing 40 may for example be implemented by a ball bearing or any other bearing that allows a relative rotation between the support structure 20 and the lifting structure 30. The rotational movement between the support structure 20 and the lifting structure 30 that is enabled by the support bearing 40 is indicated in FIG. 1 by a semi-circular double-headed arrow. The device 1 may further comprise a head 45. The head 45 may be connected to the lifting structure 30, e.g. on a distal end 33 (c.f. FIG. 4) thereof. The head 45 may be configured such that it can selectively attach to the cast product 10 such as to releasably connect the cast product 10 and the lifting structure 30 via the head 45. A lifting distance L may be defined as the radial distance between the support bearing 40 and the head 45 as schematically indicated in FIG. 1 by the straight double-headed arrow.

The head 45 may for example be implemented as a gripper or a tong or may comprise a vacuum system or a clamping mechanism or a combination of those. If the cast product 10 is magnetic (for example if it comprises sufficient levels of iron, nickel or cobalt), the head 45 may also be implemented as an electric magnet.

To lift the cast product 10 up, e.g. to remove it from the casting pit 15, the lifting structure 30 may be rotated in a first direction (in FIG. 1 counter clockwise) around the support bearing 40 so that the head 45 comes into contact with the cast product 10 in the casting pit 15. The head 45 may then be selectively attached to the cast product 10, and the lifting structure 30 is then rotated in a second, opposite direction (in FIG. 1 clockwise) around the support bearing 40 while the head 45 is attached to the cast product 10 to lift the cast product 10 up, to e.g. remove the cast product 10 from the casting pit 15.

The head 45 may be designed such that the cast product 10, when it is attached to the head 45, has a lateral/transverse distance from the lifting structure 30 so as to enable a rotation of the lifting structure 30 about the support bearing 40 without an interference between the lifting structure 30 and the cast product 10 that is attached to the head 45.

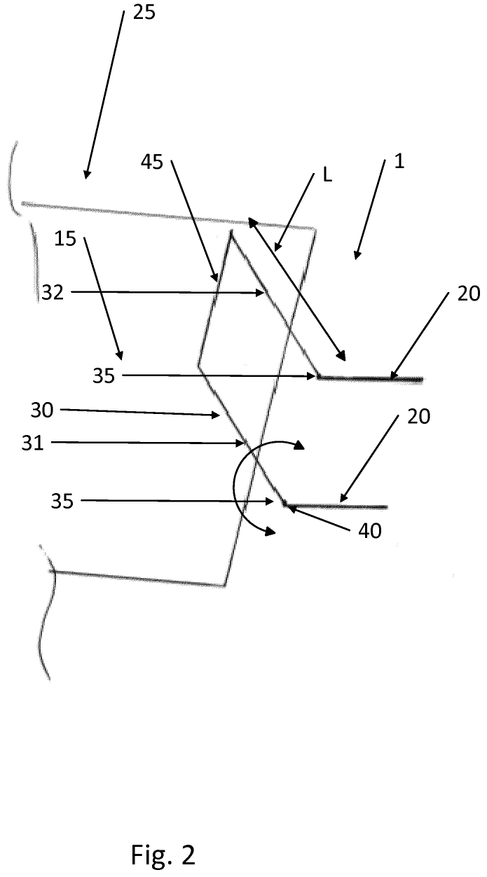

According to an embodiment and with reference to FIG. 2, the lifting structure 30 may comprise a first lifting arm 31 and a second lifting arm 32. The first lifting arm 31 and the second lifting arm 32 may each be rotatably connected to the support structure 20 via a respective support bearing 40. The head 45 may be arranged transversely with respect to the first 31 and second 32 lifting arms and may be connected to the first 31 and the second 32 lifting arms. Accordingly, the first lifting arm 31 and the second lifting arm of the lifting structure 30 and the head 45 may form a rectangular frame structure as schematically shown in FIG. 2. By using two lifting arms 31, 32 and a head 45 that is arranged therebetween, the mechanical stability of the device 1 for lifting can be increased.

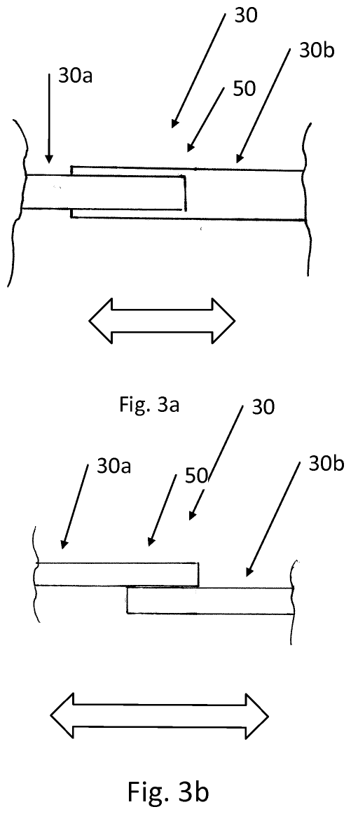

The device 1 for lifting may be configured such that the lifting distance L is adjustable. According to an embodiment, the lifting structure 30 may comprise means 50 to adjust the lifting distance L. The means 50 to adjust the lifting distance L may for example be implemented via at least one bearing, for example an axially adjustable bearing, in particular an axially adjustable telescopic bearing, that separates the lifting structure 30 into two segments 30a, 30b that are moveable with respect to each other. In embodiments in which the lifting structure 30 is implemented via the two lifting arms 31, 32, each of the lifting arms 31, 32 may be provided with a means 50 to adjust the lifting distance L. FIG. 3a shows a schematic view of a means 50 to adjust the lifting distance L according to an embodiment that is implemented as an axially adjustable telescopic bearing, wherein a segment 30a of the lifting structure 30 may penetrate the other segment 30b of the lifting structure 30b. FIG. 3b shows a schematic view of a means 50 to adjust the lifting distance L according to a further embodiment, wherein according to this embodiment the segments 30a, 30b of the lifting structure 30 are provided side by side and axially moveable relative to each other via a linear-motion bearing such as a dovetail slide or the like. According to the invention, the lifting structure 30 may also comprise more than one means 50 for adjusting the lifting distance L. According to the invention, each lifting arm 31, 32 may comprise more than one means 50 to adjust the lifting distance L. According to the invention, the device 1 for lifting may comprise one or more actuators, such as hydraulic actuators or electric actuators, to rotate the lifting structure 30 and, in embodiments providing the functionality, to adjust the lifting distance L. FIG. 4 shows an embodiment in which there are provided hydraulic actuators and in which the means 50 for adjusting the lifting distance L is implemented as a joint that allows a rotational movement between the respective segments 31a, 32a and 31b, 32b of a lifting arm 31, 32 of the lifting structure 30.

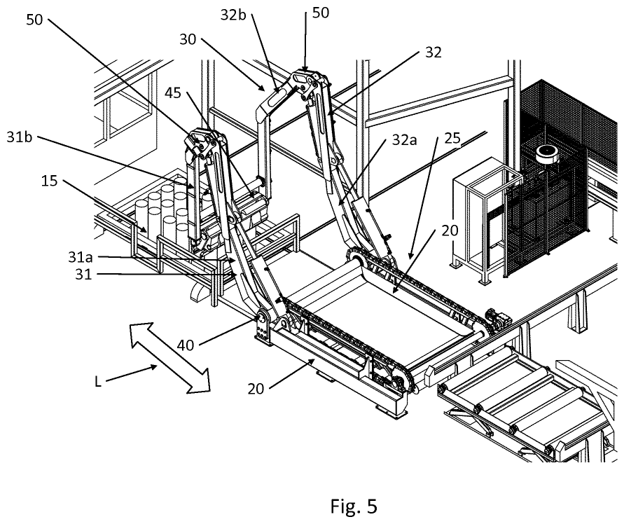

Further in this respect, FIGS. 4 to 7 show a further embodiment of a device 1 for lifting a longitudinal cast product 10 from a casting pit 15. According to the embodiment, the lifting structure 30 comprises two lifting arms 31, 32. Each of the lifting arms 31, 32 is provided with a means 50 to adjust the lifting distance L, wherein the means 50 is implemented as a pivotable/rotatable joint. The means 50 to adjust the lifting distance L separates each lifting arm 31, 32 into two segments 31a, 31b, 32a, 32b (c.f. FIG. 5) that are rotatable relative to each other to adjust the lifting distance L. The force to rotate the respective segments 31a, 31b, 32a, 32b relative to each other is generated by a respective actuator, in FIGS. 4 to 7 a hydraulic actuator, although other actuators may be used as well according to the invention. The head 45 is provided between the two lifting arms 31, 32 and connects the two lifting arms 31, 32. The head 45 is rotatable with respect to the two lifting arms 31, 32.

The head 45 may be freely rotatable so that its orientation is determined by weight and gravity, or an actuator may be provided that allows to rotate the head 45 independently of weight and gravity in a controlled manner with respect to the lifting structure 30.

The lifting structure 30 is in addition rotatable with respect to the support structure 20 via the support bearing 40. In the embodiment shown in FIGS. 4 to 7, the segments 31a and 32a of the lifting structure 30 are connected to the support structure 20 via respective support bearings 40, wherein there is further provided at least one actuator, in FIGS. 4 to 7 a hydraulic actuator, to generate a force to rotate the segments 31a and 32a with respect to the support structure 20 in a controllable manner around the support bearings 40. In the embodiment shown in FIGS. 4 to 7, four hydraulic actuators are provided, wherein there are two actuators provided for each of the two lifting arms 31, 32 of the lifting structure. For each lifting arm 31, 32, one actuator is adjustably connecting the first and second segments 31a and 31b or 32a and 32b, respectively, and one actuator is adjustably connecting the first segment 31a, 32a and the support structure 20. Accordingly, an angle between the first and second segments 31a, 31b and 32a and 32b can be adjusted independently of an angle between the first segment 31a, 32a of each lifting arm 31, 32 and the support structure 20. While the figures show an embodiment with hydraulic actuators, all types of actuators may be used with the lifting device 1 and one lifting device 1 may also comprise different types of actuators, e.g. hydraulic and electric actuators, at the same time.

Further with respect to FIGS. 4 to 7, a method for lifting longitudinal cast products 10 from a casting pit 15 according to embodiments of the invention and a device for lifting 1 according to embodiments of the invention are described. According to embodiments of the method, initially, after a casting operation, the cast products 10 are arranged in rows and columns forming a matrix arrangement in the casting pit 15 as is schematically shown in FIG. 5. Further, a longitudinal direction of the cast products 10 in the casting pit 15 is vertical. The method according to the invention comprises determining a row of cast products 10 that is to be lifted out of the casting pit 15. A row is herein defined as having a direction that is perpendicular to a direction of the lifting distance. Any such row may be selected based on practical considerations or the like. The method further involves determining a distance between a stationary part, in particular a support structure 20, of the device 1 for lifting and the row of cast products 10 to be lifted out of the casting pit 15.

Based on the determined distance, a lifting distance L of the lifting device 1 is adjusted. The method further comprises rotating the lifting structure 30 of the lifting device 1 in a first direction about/around the stationary part 20 (e.g. by rotation around the support bearing 40 and/or the means 50 to adjust the lifting distance L) such that the head 45 of the lifting device 1 is moved towards the selected row of cast products 10.

The lifting distance L is adjusted so that the head 45 of the lifting device 1 can come into contact with the selected row of cast products 10 to be lifted out of the casting pit 15. The adjusting of the lifting distance L can take place during the lifting structure 30 is rotated in the first direction, e.g. around the support bearing 40, before the lifting structure 30 is rotated in the first direction, or after the lifting structure 30 is rotated in the first direction.

The method further comprises attaching the head 45 to the cast products 10 of the determined row of cast products 10. As mentioned above, attaching the head 45 to the cast products 10 of the determined line of cast products 10 may for example comprises closing tongs, closing a gripper, or closing/turning on any other means of fastening the cast products 10 of the selected line of cast products 10 to the head 45.

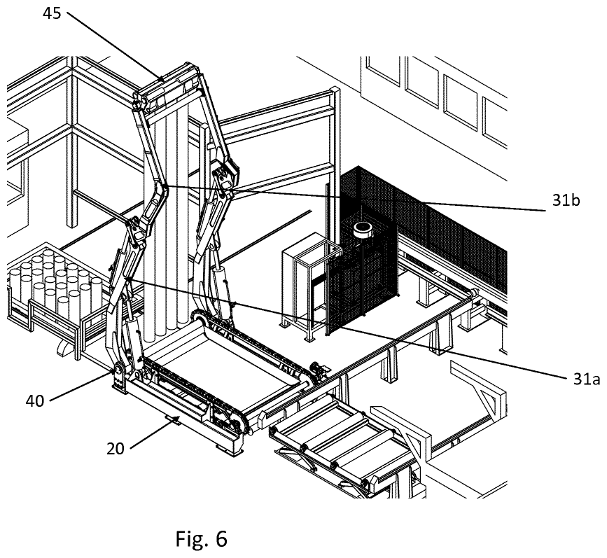

When the corresponding cast products 10 are selectively attached to the head 45, the method further comprises rotating the lifting structure 30 in a second direction that is opposite to the first direction with the cast products 10 attached to the head 45 such as to lift the cast products 10 out of the casting pit 15 as is shown in FIGS. 5 and 6.

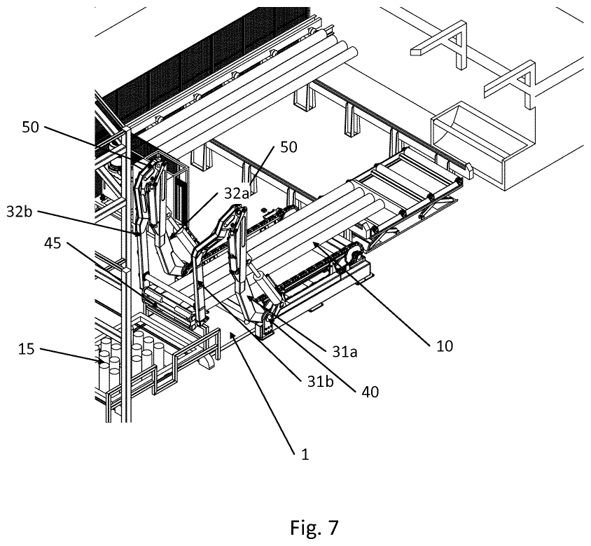

The method further comprises rotating the cast products 10 that are attached to the head 45 such that their longitudinal axes are rotated from a at least substantially vertical direction into an at least substantially horizontal direction as is shown in FIG. 7. In embodiments, the cast products 10 are rotated to place them on a conventional lay-down station for further processing such as removing head and tail ends of the cast product(s) 10 or the like. After rotating the cast products 10 into an at least substantially horizontal direction, the head 45 may be detached from the cast products 10. Rotating the cast products 10 from the at least substantially vertical direction into the at least substantially horizontal direction may be achieved by an actuator that rotates the head 45 with the cast products 10 attached thereto. Rotating the cast products 10 from the at least substantially vertical direction into the at least substantially horizontal direction may be achieved by an actuator rotating the head 45 or by other means. With reference to FIG. 4, rotating the cast products 10 from the vertical into the horizontal direction may also be achieved with a horizontal beam 70 that is attached to at least one endless chain 75 that is connected to two gears 80. The horizontal beam 70 may be parallel to the head 45. When the endless chain 75 is driven, e.g. by driving one of the corresponding gears 80, the horizontal beam 70 is moved together with the endless chain 75 and, when it comes into contact with a distal end of the cast product 10, will rotate the cast product 10 while it is still attached to the head 45 from the vertical direction into the horizontal direction. During this movement, the lifting structure 30 may be moved in a corresponding manner such as to gently lay down the cast product 10 in a horizontal direction on a conventional lay-down station 100 for further processing. The horizontal beam 70 may be connected to two endless chains 75 as is shown in FIG. 4 for better distribution of loads and strains.

According to the invention, the lifting device 1 may comprise a controller, such as an electronic control unit, to control the lifting device, e.g. the actuators comprised by the lifting device 1. The controller may be configured to carry out the method according to the invention described herein.

1. A lifting device (1) directed to removal of a longitudinal cast product (10) from a casting pit (15), wherein the cast product (10) is arranged in the casting pit (15) such that a longitudinal axis of the cast product (10) is arranged in a vertical direction, the device (1) comprising
a support structure (20) that is, optionally permanently, fixed to a ground (25), in particular a floor of a casting facility, surrounding the casting pit (15),
a lifting structure (30) with a first (31) and a second (32) longitudinal lifting arm, wherein the first lifting arm (31) and the second lifting arm (32) are each rotatably connected to the support structure (20) via a respective support bearing (40), and wherein a head (45) is arranged transversely with respect to the first (31) and second (32) lifting arm and is connected to the first (31) and the second (32) lifting arm,
where the head (45) is rotatably connected to the lifting structure (30) and that can selectively attach to the cast product (10), and wherein a lifting distance (L) is defined between the support bearing (40) and the head (45),
wherein the device (1) is configured such that in order to lift the cast product (10) from the casting pit (15), the lifting structure (30) is rotated in a first direction around the support bearing to come into contact with the cast product in the casting pit, the head is selectively attached to the cast product, and the lifting structure (30) is rotated in a second, opposite direction around the support bearing (40) while the head (45) is attached to the cast product (10) to lift the cast product from the casting pit (15), in particular out of the casting pit (15).

2. (canceled)

3. The lifting device (1) according to claim 1, wherein the lifting structure (30) comprises means (50) to adjust the lifting distance (L).

4. The lifting device (1) according to claim 3, wherein the means (50) to adjust the lifting distance (L) is implemented by at least one bearing that divides the lifting structure (30) into segments (31a, 32a, 31b, 32b) that are movable relative to each other, wherein the first lifting arm (31) and the second lifting arm (32) each comprise at least one bearing that divides/articulates the respective lifting arm (31, 32) into segments (31a, 31b, 32a, 32b) that are movable relative to each other.

5. The lifting device (1) according to claim 3, wherein the means (50) to adjust the lifting distance (L) is implemented by at least one axially adjustable bearing, in particular an axially adjustable linear telescopic bearing.

6. The lifting device (1) according to claim 4, wherein the bearing is a rotation bearing.

7. The lifting device (1) according to claim 1, wherein the lifting structure (30) comprises at least one actuator, in particular a hydraulic actuator, a pneumatic actuator or an electric actuator.

8. The lifting device (1) according to claim 1, wherein the head (45) is configured such that it can selectively attach to more than one cast product (10) simultaneously.

9. The lifting device (1) according to claim 8, wherein a plurality of cast products (10) are arranged in the casting pit (15) in rows transverse to a direction of the lifting distance (L) and in columns parallel to the direction of the lifting distance (L) such as to form a matrix arrangement, wherein the head is configured to attach to all cast products (10) of one row simultaneously, and wherein a row from the matrix arrangement is selected by adjusting the lifting distance (L) such that all cast products (10) can be lifted from the casting pit (15) in a number of lifting operations that corresponds to the number of rows in the matrix arrangement.

10. The lifting device (1) according to claim 1, wherein the device (1) comprises means (70, 75, 80) for rotating the cast products (10) from a vertical direction into a horizontal direction.

11. The lifting device (1) according to claim 1, wherein the lifting structure (30) is configured such that a vertical movement of the head (45) and a horizontal movement of the head (45) can be controlled independently from each other.

12. A method directed to removal of longitudinal cast products (10) from a casting pit (15) by the lifting device of claim 1, wherein the cast products (10) are arranged in columns and rows forming a matrix arrangement in the casting pit (15), and wherein a longitudinal direction of the cast products (10) in the casting pit (15) is vertical, the method comprising
determining a row of cast products (10) that is to be lifted out of the casting pit (15),
determining a distance between a stationary part, in particular a support structure (20), of a lifting device (1) and the line of cast products (10) to be lifted from the casting pit (15),
adjusting a lifting distance (L) of the lifting device (1) based on the determining the distance,
rotating a lifting structure (30) of the lifting device (1) in a first direction about the stationary part (20) such that a head of the lifting device (45) is moved towards the row of cast products (10),
attaching the head (45) to the cast products (10) of the determined row of cast products,
rotating the lifting structure (30) in a second, opposite direction with the cast products (10) attached to the head (45) such as to lift the cast products (10) out of the casting pit (15), and
rotating the cast products (10) such that a longitudinal axis of each cast product (10) attached to the head (45) is rotated from the vertical direction into a horizontal direction.

13. The method according to claim 12, further comprising carrying out the method with a lifting device (1), wherein the head (45) is configured such that it can selectively attach to more than one cast product (10) simultaneously, and wherein a plurality of cast products (10) are arranged in the casting pit (15) in rows transverse to a direction of the lifting distance (L) and in columns parallel to the direction of the lifting distance (L) such as to form a matrix arrangement, wherein the head is configured to attach to all cast products (10) of one row simultaneously, and wherein a row from the matrix arrangement is selected by adjusting the lifting distance (L) such that all cast products (10) can be lifted from the casting pit (15) in a number of lifting operations that corresponds to the number of rows in the matrix arrangement.

14. The method or device according to claim 12, wherein the cast product (10) consists of aluminium or an aluminium alloy.

15. The lifting device (1) according to claim 1, wherein the cast product (10) consists of aluminium or an aluminium alloy.
